(19) United States
(12) Patent Application Publication
(10) Pub. No.: US 2018/0119722 A1
(43) Pub. Date: May 3, 2018

(54) Bolt with Locked Nut

(71) Applicant: Oddmund Vik, Sandnes (NO)

(72) Inventor: Oddmund Vik, Sandnes (NO)

(21) Appl. No.: 15/524,681

(22) PCT Filed: Nov. 4, 2015
(86) PCT No.: PCT/NO2015/050203

§ 371 Date: May 5, 2017

(30) Foreign Application Priority Data
Nov. 14, 2014 (NO) 20141366

(51) Int. Cl. F16B 39/16; F16B 37/14; F16B 39/10

(52) U.S. Cl. CPC F16B 39/16; F16B 39/103; F16B 37/14

(57) ABSTRACT

A fastening assembly has a bolt and a locking nut assembly. The locking nut assembly has a first nut and a second nut. The bolt has a first threaded section having a first diameter. The bolt has a second threaded section having a second diameter. The second diameter is smaller than the first diameter. The first nut matches with the first threaded section and the second nut matches with the second threaded section. The first threaded section has a first orientation. The second threaded section has a second orientation opposite to second orientation. A locking member prevents a relative rotation between said nuts. The locking nut assembly further has a fixing member for fixing the position of the locking member with regards to the nuts. The locking member has a housing with a hole having ends that are configured for receiving said nuts in a tight manner.

### FIELD

The invention relates to a fastening assembly comprising a bolt and a locking nut assembly, wherein the locking nut assembly comprises a first nut and a second nut. The invention further relates to the bolt for use in such fastening assembly, and to the locking nut assembly for use in such fastening assembly.

### BACKGROUND

A nut is a type of fastener with a threaded hole. Nuts are usually used opposite a mating bolt to fasten a stack of parts together. The nut and bolt are kept together by a combination of their threads' friction, a slight stretch of the bolt, and compression of the parts. The most common shape is hexagonal, for similar reasons as the bolt head—6 sides give a good granularity of angles for a tool to approach from (good in tight spots), but more (and smaller) corners would be vulnerable to being rounded off. Other specialized shapes exist for certain applications, such as wing nuts for finger adjustment and captive nuts for inaccessible areas.

Nuts are graded with strength ratings compatible with their respective bolts; for example, an ISO property class 10 nut will be able to support the bolt proof strength load of an ISO property class 10.9 bolt without stripping. Likewise, an SAE class 5 nut can support the proof load of an SAE class 5 bolt, and so on.

A wide variety of nuts exists, from household hardware versions to specialized industry-specific designs that are engineered to meet various technical standards.

In normal use, a nut-and-bolt joint holds together because the bolt is under a constant tensile stress called the preload. The preload pulls the nut threads against the bolt threads, and the nut face against the bearing surface, with a constant force, so that the nut cannot rotate without overcoming the friction between these surfaces. If the joint is subjected to vibration, however, the preload increases and decreases with each cycle of movement. If the minimum preload during the vibration cycle is not enough to hold the nut firmly in contact with the bolt and the bearing surface, then the nut is likely to become loose.

To prevent this problem a second nut may be added. For this technique to be reliable, each nut must be tightened to the correct torque. The inner nut is tightened to about a quarter to a half of the torque of the outer nut. It is then held in place by a wrench while the outer nut is tightened on top using the full torque. This arrangement causes the two nuts to push on each other, creating a tensile stress in the short section of the bolt that lies between them. Even when the main joint is vibrated, the stress between the two nuts remains constant, thus holding the nut threads in constant contact with the bolt threads and preventing self-loosening. When the joint is assembled correctly, the outer nut bears the full tension of the joint. The inner nut functions merely to add a small additional force to the outer nut and does not need to be as strong, so a thin nut (also called a jam nut) can be used.

In applications where vibration or rotation may work a nut loose, various locking mechanisms may be employed as reported in the prior art, for example: adhesives, safety pins or lockwire, nylon inserts, or slightly oval-shaped threads. Furthermore, in the prior art various types of specialized locking nuts exist to prevent the problem of loosening under vibration. Examples of such locking nuts are: castellated nut, distorted thread locknut (such as centerlock nut, elliptical offset locknut, toplock nut, and philidas nut), interfering thread nut (such as the tapered thread nut), jam nut, jet nut (or K-nut), Keps nut (or K-nut or washer nut) with a free-spinning washer, plate nut, polymer insert nut (Nyloc nut), security lock nut, serrated face nut, serrated flange nut, speed nut (or sheet metal nut or Tinnerman nut), and split beam nut. All these types of locking nuts rely upon increasing the friction between the nut and the bolt, between the nut and a contact surface, or both.

### SUMMARY

The invention has for its object to remedy or to reduce at least one of the drawbacks of the prior art, or at least provide a useful alternative to prior art.

The object is achieved through features, which are specified in the description below and in the claims that follow.

The invention is defined by the independent patent claims. The dependent claims define advantageous embodiments of the invention.

In a first aspect the invention relates to a fastening assembly.

The effects of the combination of the features of the invention are as follows. By providing a bolt having two threaded sections with different diameter it is rendered possible to give each section different thread characteristics in terms of pitch, orientation, and helix angle. Such differing characteristics may then be exploited to ensure a better locking of the first nut by the second nut. Literally, the invention opens up a new design space, which may be explored for optimum nut locking results. The first threaded section and the second threaded section have threads with opposite orientation (i.e. one right-handed and one left-handed). The consequence of this is that when for instance the first nut rotates in a specific direction, as soon as the first nut touches the second nut, the friction between said nuts causes the second nut to “want to” rotate in the same direction. However, this rotation cause that the respective nuts are firmly against each other, which increases the friction even more. Thereby, further rotation of both nuts is effectively prevented. The advantageous effects are even further enhanced by the locking member, which prevents relative rotation between said nuts. As soon as the first threaded section and the second threaded section have different thread characteristics, i.e. meaning the one revolution of one nut would imply a different revolution of the other nut, the locking member very effectively blocks any movement of said nuts. A very firm nut locking effect is thereby obtained. The locking member is prevented by the fixing member from getting loose from the nuts such that they may rotate relative to each other again, i.e. a better locking effect is obtained. The locking member comprises a housing comprising a hole having ends that are configured for receiving said nuts in a tight manner. This constitutes a convenient way of preventing said nuts from rotating with regards to each other, i.e. provided that the housing can still rotate freely, rotation of said nuts is now only allowed in the same direction.

In an embodiment of the fastening assembly of the invention the first threaded section has a first pitch, and the second threaded section has a second pitch. Furthermore, the first pitch and the second pitch are different. By giving the first threaded section and a second threaded section a different pitch it is substantially prevented that said nuts may move easily in at least one direction, namely in the direction pointing to the section having the smaller pitch. This is because one revolution of the respective nut having the larger pitch would force more than one revolution of the respective nut having the smaller pitch.

In an embodiment of the fastening assembly of the invention the first threaded section has a first helix angle, and the second threaded section has a second helix angle. Furthermore, the first helix angle and the second helix angle are different. The helix angle of a threaded section is determines the pitch together with the radius of the threaded section. In other words, given a certain radius of the threaded section, it is the helix angle of the thread, which determines the pitch of the thread.

In an embodiment of the fastening assembly of the invention the fixing member is selected from a group comprising: i) an indentation in the housing provided such that in operational use it clamps between said nuts, ii) a screw, which, in operational use, is extending through a surface of the housing into the bolt or at least one of said nuts, and iii) a pivotable arm mounted on an outer surface of the housing for gripping through an opening in the housing in between said nuts at least one in of its positions in operational use. The techniques mentioned in this group of embodiments form convenient ways of fixing the locking member. The detailed description of the figures will give more details with regards to these techniques. It must be stressed, however, that the invention is by no means limited to any of these techniques, yet they are considered advantageous embodiments.

In an embodiment of the fastening assembly of the invention the locking nut assembly comprises a spacer element in between the first nut and the second nut for keeping a minimum distance between said nuts and for increasing friction between said nuts. The use of a spacer in between the nuts provides for a higher flexibility and a more robust solution in that the position of said nuts on the bolts is no longer confined to places abutting the transition region from the first radius of the first threaded section to the second radius of the second threaded section. The spacer elements may be designed with different thickness. More details of this embodiment will be given in the detailed description of the figures.

In an embodiment of the fastening assembly of the invention the spacer element has been integrated in one of said nuts. It may be advantageous in some application areas to integrate the spacer with one of said nuts, or alternatively, to provide both nuts with a spacer element, such that the total spacer width is the sum of each of said spacer elements.

In a second aspect the invention relates to the locking nut assembly in the fastening assembly according to the invention. The bolt and the locking nut assembly within the fastening assembly are cooperating parts like a plug and a socket. The invention resides in the combination, but has its implications for each of the parts. When the invention is commercialized, it is to be expected that each of said parts may be sold separately in a store or warehouse, for example. Hence, claims have been directed to each of said parts.

### BRIEF DESCRIPTION OF THE DRAWINGS

In the following is described an example of a preferred embodiment illustrated in the accompanying drawings, wherein:

FIGS. 1-4 illustrate a first embodiment of the fastening assembly of the invention;

FIGS. 5-8 illustrate a second embodiment of the fastening assembly of the invention;

FIGS. 9-10 illustrate a third embodiment of the fastening assembly of the invention;

FIG. 11 illustrates a fourth embodiment of the fastening assembly of the invention;

FIG. 12 illustrates a fifth embodiment of the fastening assembly of the invention;

FIGS. 13, 14 illustrate a sixth embodiment of the fastening assembly of the invention;

FIGS. 15a-15b show an enlarged view of the adapted locking member of FIG. 13;

FIGS. 16, 17 illustrate a seventh embodiment of the fastening assembly of the invention, and

FIGS. 18a-18b show an enlarged view of the adapted locking member of FIG. 16.

### DETAILED DESCRIPTION OF THE DRAWINGS

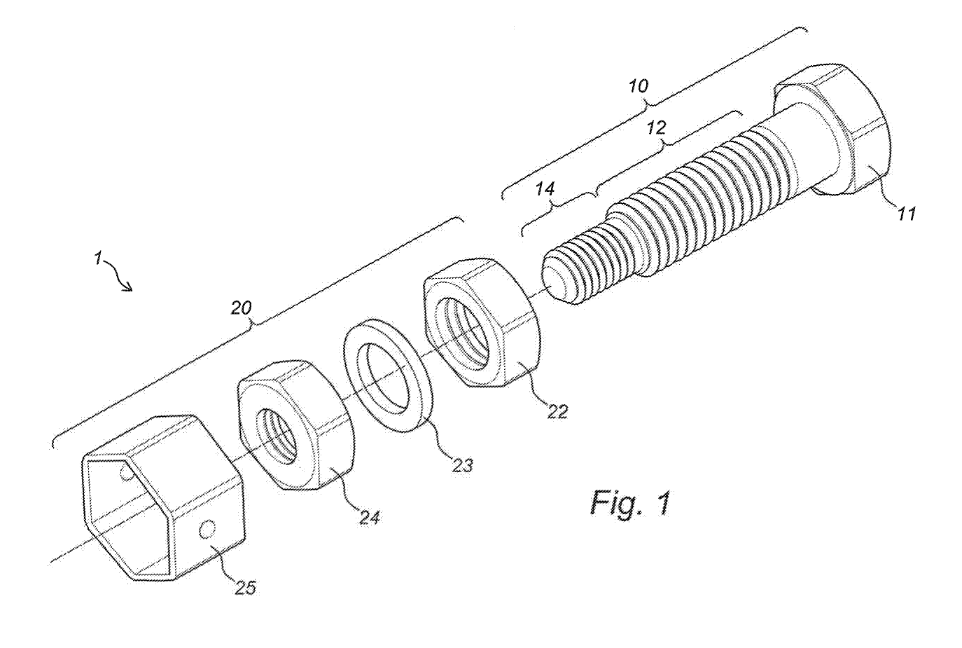

It should be noted that the above-mentioned embodiments and the ones described hereinafter illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the claims enumerating several means, several of these means may be embodied by one and the same item of hardware. The mere fact that certain measures are recited in mutually different dependent claims does not indicate that a combination of these measures cannot be used to advantage. FIGS. 1-4 illustrate a first embodiment of the fastening assembly of the invention. FIG. 1 shows an exploded view of the fastening assembly 1 and illustrates its main components in which most of the illustrated embodiments have in common. First of all, there is the bolt 10, which is special in that it comprises, besides its bolt head 11, a first threaded section 12 and a second threaded section 14 abutted to it. The special feature in accordance with this invention is that said threaded sections have different radiuses, i.e. the radius of the second threaded section 14 is smaller than that of the first threaded section 12. This feature opens up a wide range of possibilities, which will be discussed hereinafter. The fastening assembly 1 further comprises a locking nut assembly 20, which in this embodiment comprises a first nut 22, a spacer element 23 (or ring), a second nut 24, and a locking member 25. Both the spacer element 23 and the locking member 25 are not essential for the invention, yet they do provide very advantageous embodiments having a very good locking effect of the nuts. It is important to note that the first nut 22 is designed to match with the first threaded section 12 and the second nut 24 is designed to match with the second threaded section, at least in terms of the inner diameter of the respective inner threads of said nuts 22, 24. In the embodiments discussed in this detailed description the outer diameter of said nuts 22, 24 is chosen the same, but this is not essential to the invention.

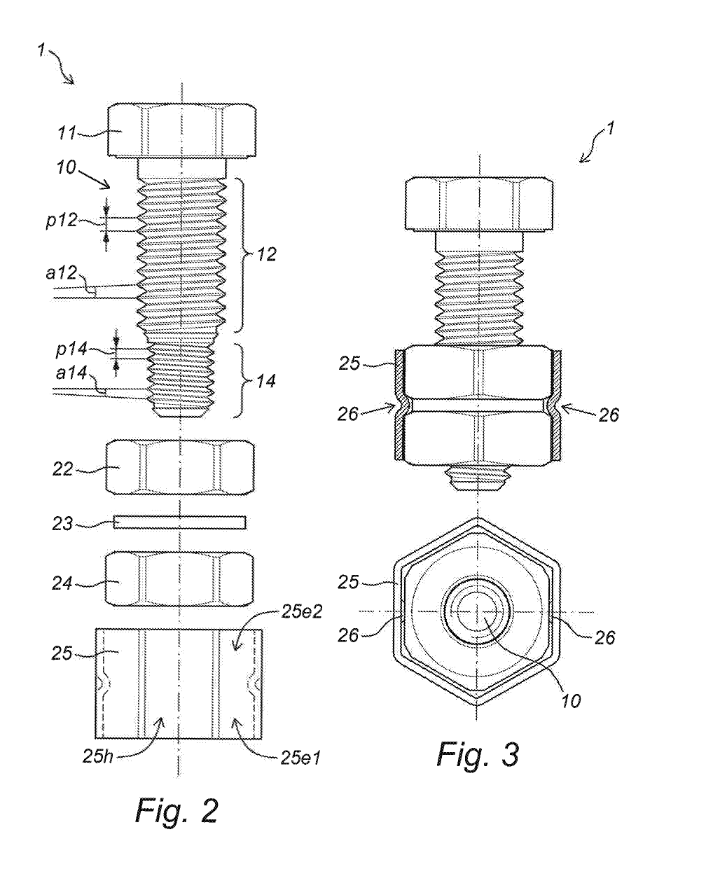

FIG. 2 illustrates the special features with regards to the bolt 10 in more detail. As mentioned above, the choice for two different threaded sections 12, 14 on a single bolt 10, each having a different radius opens up a wide variety of design parameters. First of all, the respective pitch p12 of the first threaded section 12 may be chosen different from the respective pitch p14 of the second threaded section 14, as illustrated in FIG. 2. Second, the respective helix angle a12 of the first threaded section 12 may be chosen different from the respective helix angle a14 of the second threaded section, as illustrated in the same FIG. 2. Third, as illustrated in the FIGS. 1 to 3, the orientation of the threads of the first threaded section 12 and the second threaded section 14 is different. In this embodiment the first threaded section 12 is right-handed or clockwise oriented and the second threaded section 14 is left-handed or counter-clockwise oriented. This opposite orientation of the threads constitutes a very advantageous embodiment, in particular when it is used in combination with the locking member 25 for preventing relative rotation between said nuts 12, 14. Nevertheless, such opposite orientation is not essential, as will be explained hereinafter. Obviously, the thread orientations of the respective nuts 22, 24 are to be adapted in accordance with thread orientations of said threaded sections 12, 14.

With reference to FIG. 2, the locking member 25 in this embodiment comprises a housing having a hole 25h having a first end 25e1 and a second end 25e2. Said ends 25e1, 25e2 are for receiving and enclosing said nuts 22, 24.

With reference to FIG. 3, there is illustrated indents 26 in said housing 25 that serve to keep the locking member 25 in place. In operational use these indents 26 grip in between said nuts 22, 24 at the location of the spacer element 23. The purpose of the locking element 25 is to prevent relative rotation between said nuts 22, 24, and optionally also to keep said nuts 22, 24 together. There is various ways of making the intends 26, for example by means of local mechanical deformation of a housing 25 without indents. However, other processes are also possible.

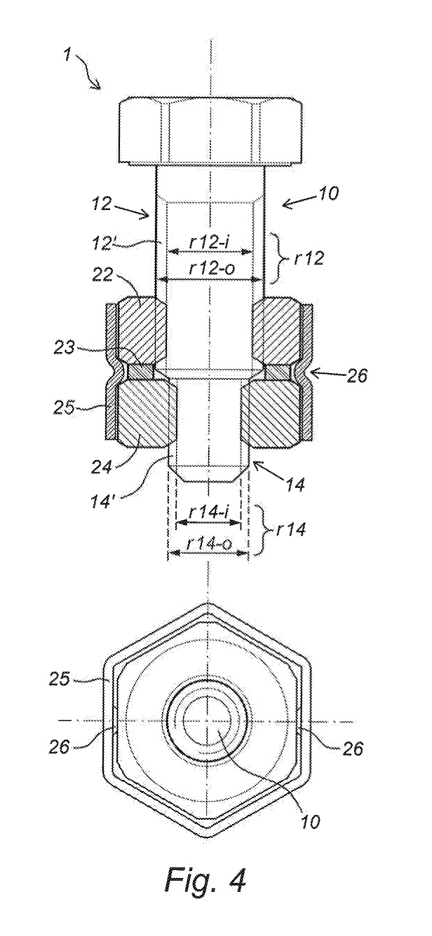

With reference to FIG. 4, there is illustrated the respective threaded sections 12, 14 of the bolt 10, albeit in a schematic manner. The first threaded section 12 comprises threads 12′ having a first radius r12. It is commonly known that a certain radius of a threaded section actually implies an inner radius r12i and an outer radius r12o in accordance with the respective ISO and other standards. Similarly, the second threaded section 14 comprises threads 14′ having a second radius r14, which is smaller than the first radius r12. The second radius r14 implies an inner radius r14-i and an outer radius r14-o in conformity with the standards.

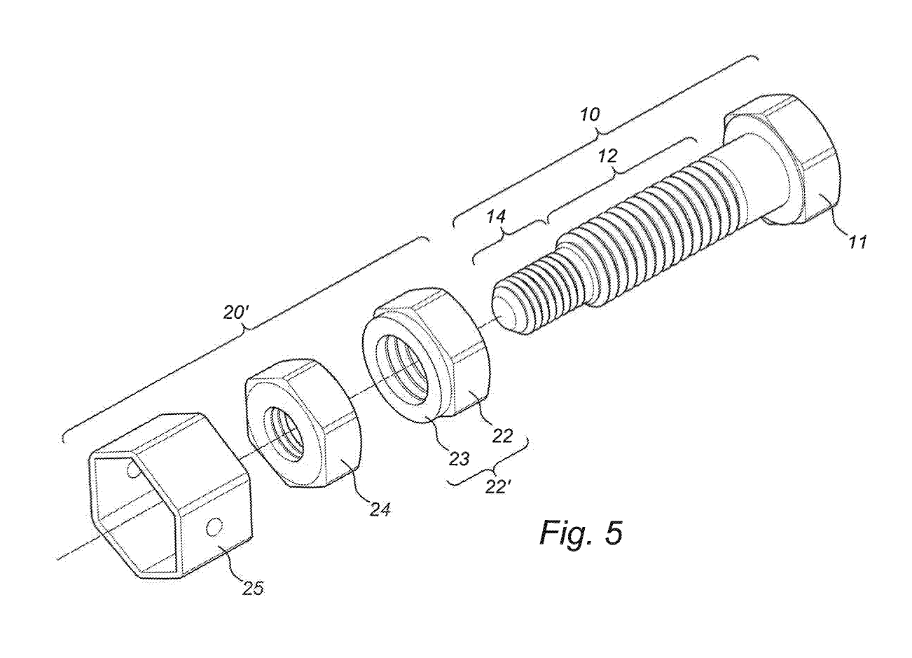

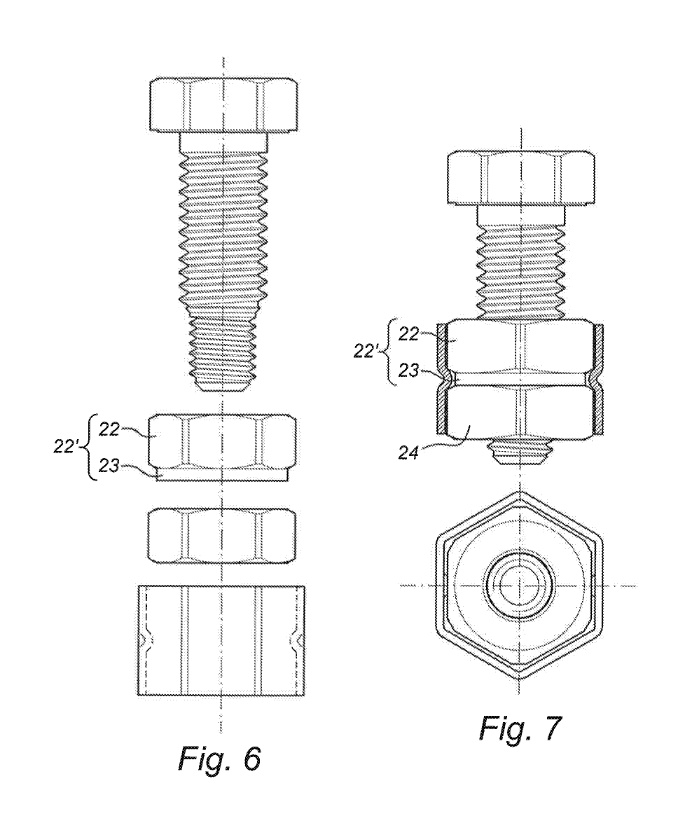

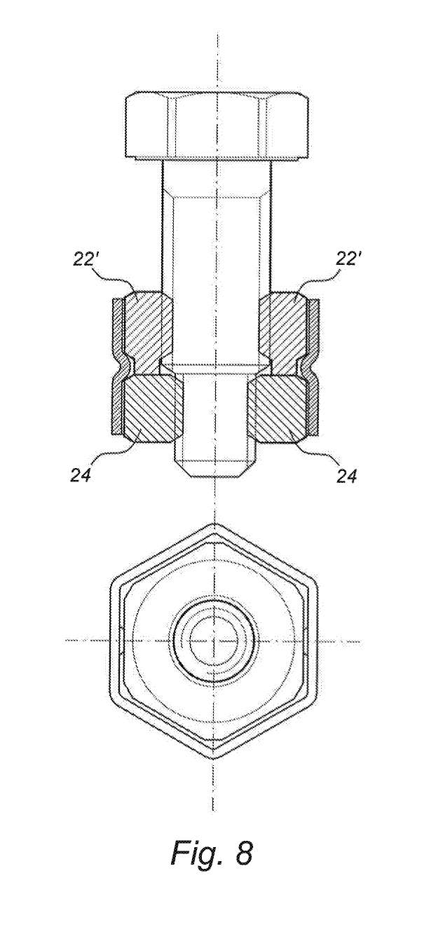

FIGS. 5-8 illustrate a second embodiment of the fastening assembly of the invention. This embodiment will only be discussed in as far as it differs from the first embodiment. A main difference is that the spacer element 23 is now integrated in the first nut 22, i.e. an adapted first nut 22′ is used. The advantage of this embodiment is that it saves parts and may therefore be more convenient to use in certain applications.

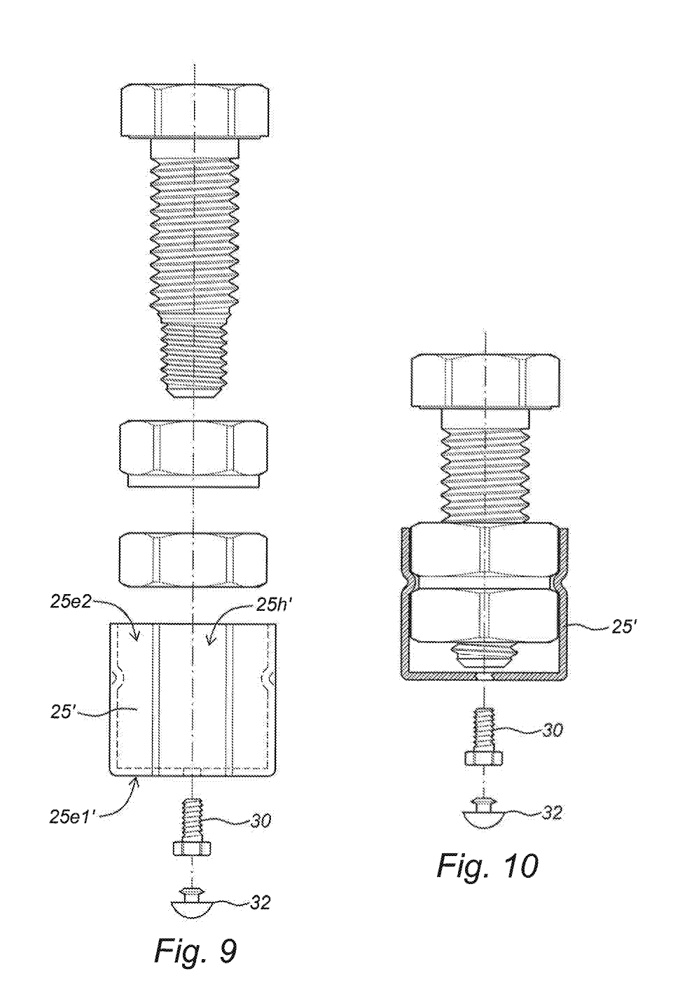

FIGS. 9-10 illustrate a third embodiment of the fastening assembly of the invention. This embodiment will only be discussed in as far as it differs from the second embodiment. A main difference is that the locking member 25′ is different. One of its ends 25e1′ is closed making the hole for receiving said nuts 22, 24 effectively a blind hole 25h′. In order to keep the locking member 25′ in this embodiment in place this embodiment also comprises the indents 26. At the closed end 25e1′ of the locking member 25′ there is provided a hole as illustrated in FIG. 10. When the locking member 25′ has been mounted this hole may be closed with a protection cap 32 as illustrated in the Figures. In the embodiment of FIGS. 9 and 10 this hole is designed to receive a small screw 30. The hole in the locking member 25′ is provided with threads, which correspond with the threads of the screw. When the screw 30 is screwed in the hole of the locking member 25′, it will eventually hit the bolt and now, when the screw is rotated further, the threads in the hole of the locking member 25′ will cause the locking member 25′ to be pulled off from the nuts by means of the small screw 30. The embodiment of FIGS. 9 and 10 thus provides for a convenient way of removing the locking member 25′ from the bolts. Another advantage of the embodiment of FIGS. 9 and 10 is that the locking member 25′ may contain anti-corrosion material for example.

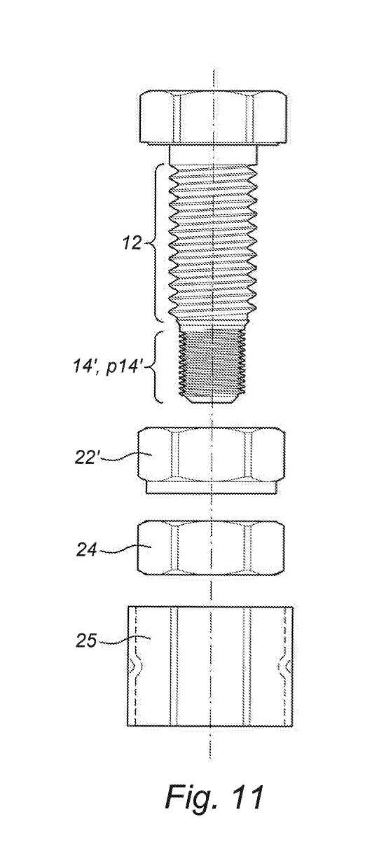

FIG. 11 illustrates a fourth embodiment of the fastening assembly of the invention. This embodiment will only be discussed in as far as it differs from the previous embodiments. A main difference in this embodiment is that the second threaded section 14′ is adapted with a different pitch p14′, here a smaller pitch. An effect of this embodiment is that a single revolution of the first nut 22′ in the downward direction implies more than one revolution of the second nut 24. Expressed differently, the second nut 24 slows down the first nut 22′. Obviously, when the locking member 25 is provided on said nuts 22, 24 a firm locking effect is achieved, not in the least because of the oppositely oriented threaded sections.

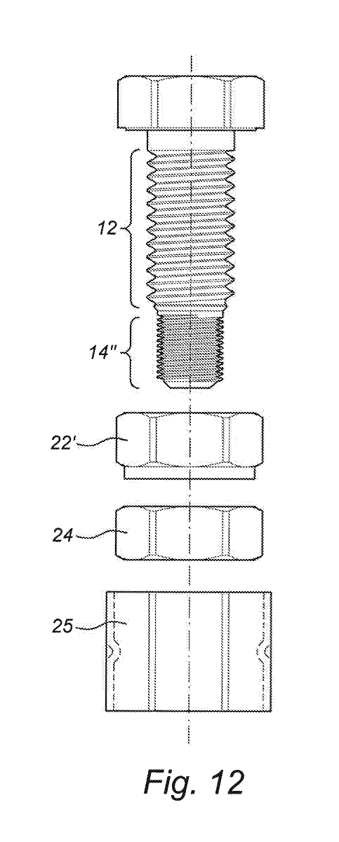

FIG. 12 illustrates a fifth embodiment of the fastening assembly of the invention. This embodiment will only be discussed in as far as it differs from the previous embodiments. In this embodiment the second threaded section 14″ is further adapted in that the orientation of the threads is now the same as for the first threaded section 12. In this embodiment is the second threaded section 14′ is also has a smaller pitch p14′ than the first section. This leads to the same effect as in the embodiment of FIG. 11 in that a single revolution of the first nut 22′ in the downward direction implies more than one revolution of the second nut 24. Likewise, when the locking member 25 is provided on said nuts 22, 24 a firm locking effect is achieved, despite the same orientation of said threaded sections.

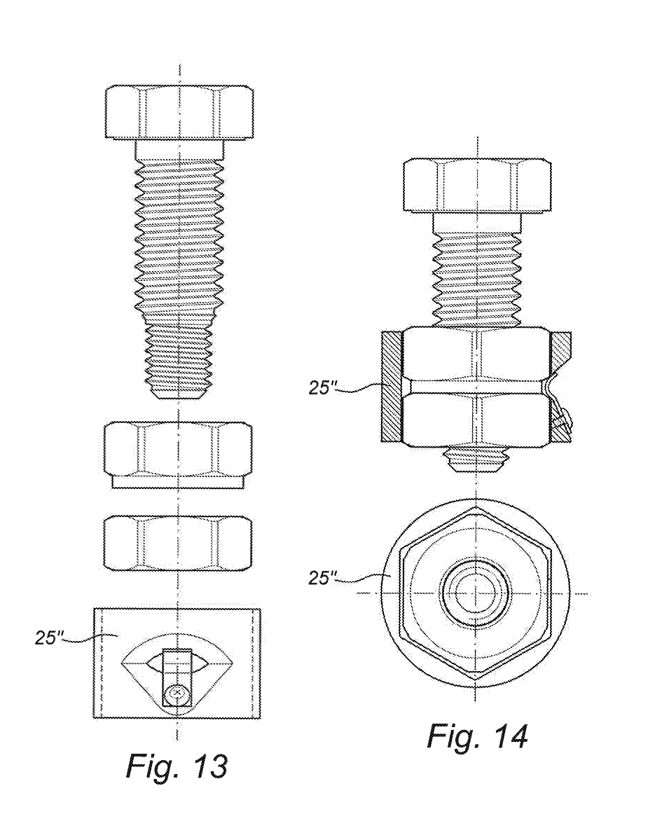

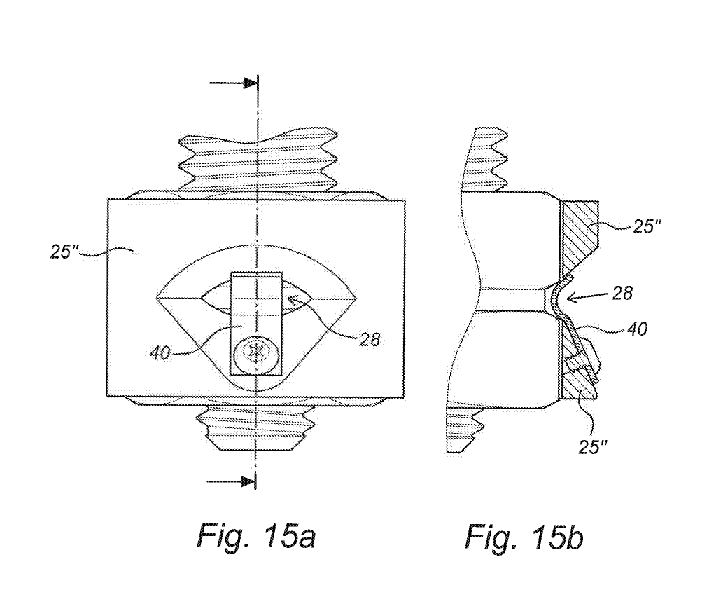

FIGS. 13, 14 illustrate a sixth embodiment of the fastening assembly of the invention. FIGS. 15a-15b show an enlarged view of the adapted locking member of FIG. 13. This embodiment will be discussed in as far as it differs from the second embodiment as disclosed in FIGS. 5 to 9. A main difference is that is comprises a further adapted locking member 25″. Instead of using indents 26 in the locking member 25, now the locking member 25″ (housing) is provided with an opening 28 and a pivotable arm 40 mounted on the housing 25″ one side of the opening 28. The pivotable arm 40 may be position such that its end grips through opening 28 in between said nuts to keep the housing 25″ in place.

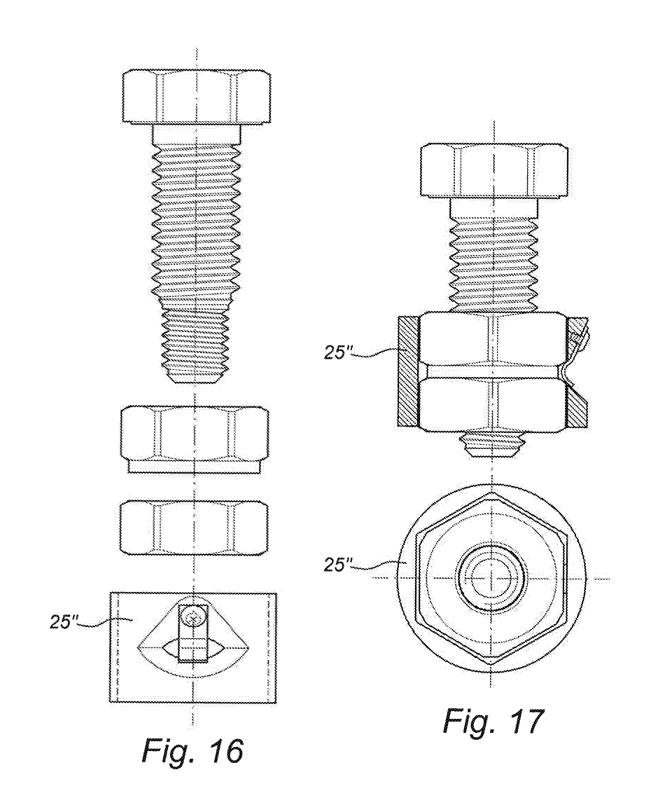

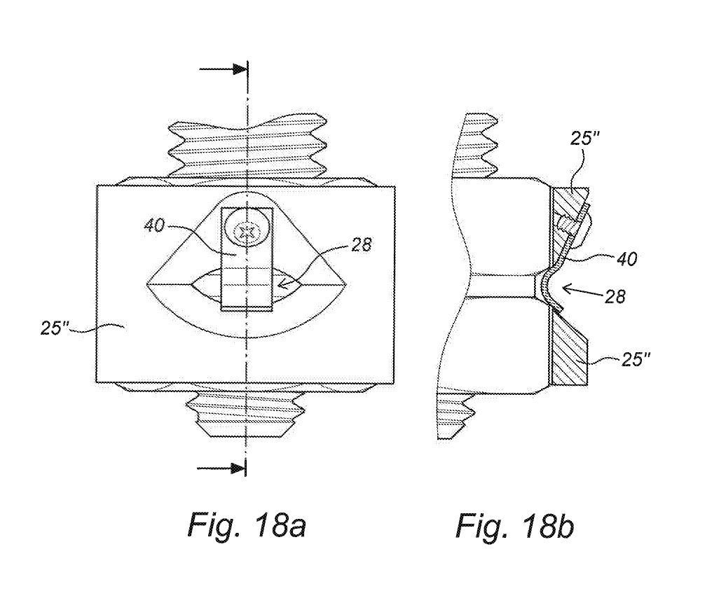

FIGS. 16, 17 illustrate a seventh embodiment of the fastening assembly of the invention. FIGS. 18a-18b show an enlarged view of the adapted locking member of FIG. 16. These figures show the same locking member as FIGS. 13-15b, albeit that the orientation of the locking member is now inverted, i.e. upside down. The advantage of this embodiment is that it is now easier to access and lift up the pivotable arm when mounted, for instance with a screwdriver.

The invention thus relates to providing a fastening assembly having a nut and a bolt with improved locking functionality. The invention may be applied in a very large variety of application areas. One of such areas that will benefit from the current invention a lot is the oil and gas recovery industry, both onshore as well as offshore.

Many variations to the embodiments described are possible, and many embodiments may be advantageously combined. Instead of using a locking member 25 it is also possible to replace the second nut 24 with a rubber nut for example or another material having a very high friction coefficient with the bolt 10. Such fastening assembly still falls within the scope of the appended claims.

It must be further noted that in accordance with conventional use of bolt and nut assemblies, in the invention additional washers may be used. Such washers may be conventionally placed in between the first nut and the contact surface of the object through which the bolt extends, or in between the bolt head and the opposite contact surface, or both.

1. Fastening assembly comprising a bolt and a locking nut assembly, wherein the locking nut assembly comprises a first nut and a second nut, wherein the bolt comprises a first threaded section having a first diameter, wherein the bolt further comprises a second threaded section having a second diameter, wherein the second diameter is smaller than the first diameter, and in that the first nut matches with the first threaded section and the second nut matches with the second threaded section, the first threaded section having a first orientation, the second threaded section having a second orientation, wherein the first orientation is opposite to second orientation, wherein the locking nut assembly further comprises a locking member for preventing a relative rotation between said nuts, wherein the locking nut assembly further comprises a fixing member for fixing the position of the locking member with regards to the nuts, wherein the locking member comprises a housing comprising a hole having ends that are configured for receiving said nuts in a tight manner.

2. The fastening assembly according to claim 1, the first threaded section having a first pitch, the second threaded section having a second pitch, wherein the first pitch and the second pitch are different.

3. The fastening assembly according to claim 1, the first threaded section having a first helix angle, the second threaded section having a second helix angle, wherein the first helix angle and the second helix angle are different.

4. The fastening assembly according to claim 1, wherein the fixing member is selected from a group comprising:
i) an indentation in the housing provided such that in operational use it clamps between said nuts,
ii) a screw, which, in operational use, is extending through a surface of the housing into the bolt or at least one of said nuts, and
iii) a pivotable arm mounted on an outer surface of the housing for gripping through an opening in the housing in between said nuts at least one in of its positions in operational use.

5. The fastening assembly according to claim 1, wherein the locking nut assembly comprises a spacer element in between the first nut and the second nut for keeping a minimum distance between said nuts and for increasing friction between said nuts.

6. The fastening assembly according to claim 5, wherein the spacer element has been integrated in one of said nuts.

8-12. (canceled)
